(19) United States
(12) Patent Application Publication
(10) Pub. No.: US 2025/0051229 A1
(43) Pub. Date: Feb. 13, 2025

(54) METHOD FOR PRODUCING AN AGGREGATE, AND AGGREGATE

(71) Applicant: OLIMENT R GmbH, Rötha OT Espenhain (DE)

(72) Inventor: Frank BELLMANN, Weimar (DE)

(73) Assignee: OLIMENT R GmbH, Rötha OT Espenhain (DE)

(21) Appl. No.: 18/722,826

(22) PCT Filed: Jan. 12, 2023
(86) PCT No.: PCT/EP2023/050601

§ 371 Date: Jun. 21, 2024

(30) Foreign Application Priority Data
Jan. 12, 2022 (WO) PCT/EP2022/050562

(51) Int. Cl. C04B 14/04; C04B 14/26; C04B 18/02

(52) U.S. Cl. CPC C04B 14/042; C04B 14/26; C04B 18/021

(57) ABSTRACT

The invention relates to a method for producing an aggregate comprising the steps of providing a starting product comprising at least 20% by mass magnesium silicate hydrate, crushing to a fineness corresponding to a BET surface area of 0.1 m₂/g or finer, homogenizing the starting product, and at least partially dewatering the starting product of bound water by means of thermal treatment in a thermal treatment unit, contacting the dewatered starting product with CO₂, wherein CO₂ reacts with the dewatered magnesium silicate hydrate and the CO₂ is bound in the resulting magnesium carbonate hydrate and/or magnesium carbonate, and compressing and compacting the dewatered starting product before or after contacting with CO₂ to solids for producing the aggregate. The invention also relates to an aggregate.

The invention relates to a method for producing an aggregate, in which CO₂ is sequestered, as well as to an aggregate.

In the construction industry, natural and artificial aggregates are referred to as aggregates. These can, for example, come from natural deposits or be produced during the recycling of building materials or as an industrial by-product. Alternative terms in the construction industry that are no longer actually but have roughly the same meaning are concrete aggregate, mineral mixture, mineral mixture or mineral material.

In principle, an aggregate can be processed together with a binding agent, which is usually cement, and water to form concrete. However, asphalt is also a mixture of aggregate and bitumen. The grain shape, strength and grading curve of the aggregate can have among other things at this juncture an influence on the properties of the resulting building material.

Aggregate without binders is used, for example, to create unpaved paths, seepage and frost protection packs, capillary-breaking layers and similar fills.

Carbon dioxide (CO₂) acts as a greenhouse gas in the atmosphere and is considered to be one of the main causes of man-made global warming. In addition to the fundamental reduction of CO₂ emissions, parallel efforts are being made to bind CO₂ already being in the atmosphere. Binding CO₂ can also be used to make manufacturing processes that produce large quantities of CO₂, such as cement production, CO₂-neutral.

Sequestration of CO₂ refers in particular to the removal of CO₂ from the atmosphere, ideally in such a way that the CO₂ is combined with other substances so that it cannot escape again. Various proposals are known for this. One possibility is to use olivine.

Olivine is a mineral of the general composition A₂[SiO₄], wherein various divalent ions can occur for A, such as magnesium (forsterite, Mg₂SiO₄), iron (Fe₂SiO₄, fayalite), manganese (Mn₂SiO₄, tephroite) as well as other ions and a combination of the various cations, as olivine is a solid solution series.

The patent literature on accelerating the sequestration of carbon dioxide in a reaction with olivine is very extensive. Many processes for sequestering CO₂ using olivine are based on the following principle and differ mainly in the way the reaction is accelerated.

Mg₂SiO₄+2CO₂→2MgCO₃+SiO₂

According to WO 2007/069902, the reaction should be accelerated by grinding and adjusting certain pH values, WO 2008/140821 and WO2008/061305 suggest accelerating the reaction by high temperatures, high CO₂ partial pressures and high fineness of the olivine. WO 2008/101293 proposes the addition of ammonium, WO 2007/106883 the addition of a base and U.S. Pat. No. 4,944,928 the addition of hydrochloric acid.

In addition to these processes, there are a large number of other processes that are capable of accelerating the sequestration of carbon dioxide during the reaction with olivine, wherein all of these processes use complicated technologies and expensive starting materials.

In the project called CO2min, an attempt was made to combine such a carbonation of olivine with cement production. The aim is to capture CO₂ emissions from the cement industry by carbonating olivine. As a result, cement production will continue unchanged while retaining the existing high-temperature process. The resulting carbon dioxide is bound by a reaction with olivine in the form of magnesium carbonate and SiO₂. This arising material can then be added to the cement and thus disposed of. However, it is obviously not possible to convert the olivine completely into magnesium carbonate, see D. Kremer, H. Wotruba: Separation of products from mineral sequestration of CO₂ with primary and secondary materials. Minerals, Volume 10 (2020), 1098 ff. Very high CO₂ partial pressures (17 bar) and high temperatures (175° C.) were used in the project. Despite the autoclave treatment, the degree of conversion of the olivine was low and very large quantities of olivine would be needed to compensate for the low degree of conversion. The selected process technology is also probably not suitable for binding carbon dioxide on an industrial scale.

Another idea for binding carbon dioxide through a reaction with olivine was also developed in the Netherlands, see R. D. Schuiling, P. Krijgsman: Enhanced weathering: An effective and cheap tool to sequester CO₂. Climate change, Vol. 74 (2006), 349-354. Olivine is spread on arable land or distributed on beaches. If the olivine is dissolved in magnesium ions, the precipitation or seawater could simultaneously absorb carbon dioxide in the form of HCO₃⁻ ions according to the following equation.

Mg₂SiO₄+4CO₂+2H₂O→2Mg²⁺+4HCO₃⁻+SiO₂

However, a laboratory experiment at the University of Hamburg showed that the described reaction does not take place in the form described. Even if the entire arable land of the world were sprinkled with olivine, only 0.2% of global carbon dioxide emissions could be captured, see T. Amann et al.: Enhanced weathering and related element fluxes—a cropland mesocosm approach. Bio geosciences, Volume 17 (2020), 103-109.

The object underlying the invention is that of providing an efficient method for producing an aggregate in which CO₂ can also be sequestered.

According to the invention, this object is achieved by means of a method having the features of claim 1 and by means of an aggregate having the features of claim 15.

Further advantageous embodiments are specified in the dependent claims and the further description.

According to claim 1, it is provided that first a starting product is provided which comprises at least 20% by mass of magnesium silicate hydrate (Mg₃Si₂O₅(OH)₄, Mg₃Si₄O₁₀(OH)₂), preferably at least 40% by mass, more preferably at least 60% by mass, still more preferably at least 80% by mass. An example of this is serpentinite. Serpentinite is a metamorphic rock which is formed by natural transformation, in particular weathering, of ultramafic rocks. Advantageously, the starting material should not contain any SiO₂ and no substance should be added that releases SiO₂ during thermal treatment. SiO₂ could react with the magnesium silicate hydrate during subsequent thermal treatment and thereby reduce the product quality.

An important mineral in ultramafic rocks is olivine. This is a mixed crystal series between fayalite (Fe₂SiO₄), forsterite (Mg₂SiO₄), tephroite (Mn₂SiO₄) and other minerals of the form A₂[SiO₄]. Natural olivine deposits are documented and the olivine is often a magnesium-rich material with iron content.

The underlying reactions that occur during weathering are as follows, wherein these are given here in simplified form, starting from forsterite (Mg₂SiO₄)

2Mg₂SiO₄+3H₂O→Mg₃Si₂O₅(OH)₄+Mg(OH)₂ (1)

3Mg₂SiO₄+5SiO₂+2H₂O→2Mg₃Si₄O₁₀(OH)₂ (2)

The magnesium silicate hydrate (Mg₃Si₂O₅(OH)₄, Mg₃Si₄O₁₀(OH)₂) can be present in the form of lizardite, antigorite, talc and other forms. It should be noted that the stoichiometric water content is sometimes lower—in the range of 13% by mass for antigorite—than the water content determined by testing—in the range of 16% by mass to 20% by mass. This can be explained by the fact that some of the materials are so fine that water can also adhere to their surface.

Similarly, such deviations from the stoichiometry also apply to the ratio between Mg and Si. Furthermore, foreign ions, such as Fe, can also be incorporated into the reaction products. However, other reaction products such as hydromagnesite, hematite, magnetite or gibbsite can also be formed. This depends in each case on the exact composition of the starting product. All or some of the reaction products may contain iron, carbonate and alkalis or other foreign ions.

This starting product is crushed to a fineness corresponding to a BET surface area of 0.1 m²/g or finer, wherein the BET surface area can be determined according to the standard DIN ISO 9277:2003-05 “Determination of the specific surface area of solids by gas adsorption” using the BET method. A BET surface area of 0.5 m²/g is advantageous, even more preferably a BET surface area of 1.0 m²/g or even finer.

This crushing can be achieved by grinding. Depending on the source of the magnesium silicate hydrate, crushing within the meaning of the invention can also take place during or as a result of mining, extraction or, more generally, production.

Once the starting product has been prepared, follows the homogenization of the starting product, if it is necessary. The serpentinite cited as an example is a material from natural deposits. Experience has shown that it is neither available in pure form nor homogenized. Homogenization can be carried out using a mixer, for example, or at the same time as crushing to the desired fineness.

Subsequently, the homogenized starting product is at least partially dewatered from bound water by means of thermal treatment in a thermal treatment unit. The thermal treatment proposed here can also be referred to as tempering or calcination. Bound water is sometimes also referred to as water of crystallization. It must be distinguished from unbound water, which can be regarded as free H₂O. Complete dewatering can be achieved at great expense. According to the invention, the water content of bound water should be reduced by at least 60%, preferably by at least 80%, even more preferably by at least 90%.

For thermal treatment, the starting product can be heated to a temperature between 180° C. and 1000° C. Depending on the fineness present, heating for just a few minutes is already sufficient. Temperatures between 300° C. and 800° C. are preferred, even more advantageously between 500° C. and 700° C.

In this step, the magnesium silicate hydrate (Mg₃SiO₂₅(OH)₄, Mg₃Si₄O₁₀(OH)₂) present in the starting product is at least partially converted into dewatered magnesium silicate hydrate, which can be represented in simplified form as xMgO·SiO₂·yH₂O by dehydration. Dehydration here refers to the reduction of crystalline water or water of crystallization in the converted starting product.

The underlying chemical processes are here, again simplified, as follows:

Mg₃Si₂O₅(OH)₄→2xMgO·SiO₂yH₂O+zH₂O (3)

Mg₃Si₄O₁₀(OH)₂→2aMgO·SiO₂·bH₂O+cH₂O (4)

wherein (3) produces a largely amorphous reaction product with a Mg to Si ratio of 1.5 to 2 and a bound water content of around 3%. The reaction product formed in equation (4) has an even lower Mg to Si ratio. Hence the variables a, b, c, x, y and z. This depends in each case on the exact composition of the starting product and the treatment parameters.

After dewatering, the water content of the bound water in the converted, dewatered starting product is preferably less than 10% by mass, more advantageously less than 5% by mass, even more preferably less than 3.5% by mass, still more preferably less than 2.5% by mass.

The dewatered starting product is therefore present as a multiphase product. Other possible secondary phases are hematite, magnetite, enstatite, feldspars, pyroxenes, quartz and amorphous phases.

Once the starting product has been dewatered, it can be contacted with CO₂. The CO₂ reacts here with the existing dewatered magnesium silicate hydrate (xMgO·SiO₂·yH₂O). The CO₂ is mainly bound in the resulting magnesium carbonate (MgCO3) and/or magnesium carbonate hydrate (MgCO₃*mH₂O). Magnesium carbonate is referred to by the mineral name magnesite. Magnesium carbonate hydrates include, for example, barringtonite (m=2), nesquehonite (m=3) and landsfordite (m=5). Further, there are also basic magnesium carbonate hydrates such as artinite, hydromagnesite and dypingite.

The underlying chemical processes are expressed simplified and generalized as follows:

xMgO·SiO₂·yH₂O+qH₂O+xCO₂→xMgCO₃·(q+y)/xH₂O+SiO₂ (5)

where q, x and y represent corresponding variables. These can be zero in some cases. It should also be noted that in equation (5) the dewatered magnesium silicate hydrate only appears as xMgO·SiO₂·yH₂O, as it has been (incompletely) dewatered. Ideally, the above reactions according to the invention produce little or no Mg(OH)₂.

Before or after the step of contacting the dewatered starting product with CO₂, it is intended that this is pressed and compacted into solid bodies for the production of the aggregate. With the optional addition of binder, this can produce an essentially solid body that can be used as aggregate. No SiO₂ should be added before pressing and compacting, as otherwise too much CaO, Al₂O₃ or other additives are required to bind the SiO₂.

In accordance with the invention, it was recognized that by expelling crystal water from natural materials such as weathered ultramafic rocks, for example serpentinite, an intermediate material can be produced that is suitable for binding CO₂ to a high degree.

In this way, large quantities of CO₂ can be bound with relatively little energy input. For example, it is possible to bind approx. 0.6 t of CO₂ within a few hours with approx. 1 t of serpentinite by using the method according to the invention.

It is preferable if the thermal treatment of the starting product is carried out at a temperature of at least 550° C. and/or at most 750° C. and if the starting product is thermally treated for at least 5 min, advantageously 15 min, preferably 30 min, even more preferably at least 60 min.

It is advantageous to maintain the dewatering temperature characteristic of a particular material as precisely as possible with a deviation of less than 20° C. If the temperature during thermal treatment is too low, the magnesium silicate hydrate, such as serpentinite, will not dehydrate or will dehydrate insufficiently. If the temperature is too high, the magnesium silicate hydrate is largely converted into olivine, which has poor reactivity. Only in a narrow temperature range does dehydration occur with little or no olivine formation. Instead, the dewatered starting product forms in the form of an X-ray amorphous phase with a low residual water content of between 2 and 5% by mass. This phase has a high reactivity and is the target product of the thermal treatment.

It is therefore preferable if the thermal treatment unit has an essentially homogeneous temperature distribution. This enables good dewatering to be achieved without the formation of unwanted by-products. It is therefore advantageous if the furnace is not heated directly with a flame, in order to maintain the desired dewatering temperature in the furnace as precisely as possible and for a large part of the material's residence time. In this case, the material would be temporarily exposed to very high temperatures, which would lead to olivine formation. For example, the temperature distribution in a directly heated rotary kiln is too uneven. It is therefore advantageous if a rotary kiln, in particular an indirectly heated rotary kiln without open flames in the reaction chamber, is used as the thermal treatment unit. The temperature during thermal treatment, which can also be referred to as the firing temperature, can be controlled particularly precisely in electrically heated furnaces. Electric heating should be used, in particular to precisely maintain the target temperature in the furnace chamber. It is advantageous to heat the kiln with electrical energy from renewable energy sources, as no CO₂ emissions and exhaust gases are produced and no fuel is consumed. In contrast, preheating is also possible using other heat sources, in particular a heat exchanger, which removes some of the heat from the dewatered starting product, such as the fired serpentinite, and thereby cools it, while at the same time this heat is supplied to unfired serpentinite. The use of flue gas from combustion processes should also be avoided where possible, as this can lead to uncontrolled binding of CO₂, for example.

In order to achieve a sufficient dwell time at the target temperature, rotary kilns are preferred, as they have a large volume and therefore a high throughput can be achieved. Furthermore, rotary kilns are characterized by good thermal efficiency.

Thermal treatment is particularly efficient with small particle sizes of magnesium silicate hydrate, such as ground serpentinite, as in this case the water bound in the particles can be expelled more quickly and efficiently. At the same time, a low water vapor partial pressure in the thermal treatment unit, such as a furnace chamber, facilitates the formation of the reactive phase for binding the CO₂. A low water vapor partial pressure can be achieved by air purging the furnace chamber.

After thermal treatment, the dewatered starting product, such as tempered serpentinite, is usually available as a powder. This powder can either be contacted directly with CO₂ or pressed into a solid beforehand. Further crushing is not necessary and it has even been found that milling has a negative effect on further processes.

The pressing and compacting of the dewatered starting product can be carried out in such a way that the solids are formed with a volume of between 1 mm³ and 30,000 mm³. These sizes are particularly suitable for use as aggregate.

Furthermore, it has been shown that pressing and compacting is preferably carried out in such a way that the solids are formed with a porosity of less than 30% by volume, preferably less than 20% by volume, more advantageously less than 10% by volume. On the one hand, in the event of subsequent contact with CO₂, this can also easily reach material not lying on the surface due to the porosity, and on the other hand, this type of aggregate can be used particularly well.

The higher the compaction and the lower the porosity of the solids are, the greater is the subsequent strength of the aggregate, which is also known as sand or gravel. The compacted solids should be so solid that the subsequent method steps do not lead to damage.

If the dewatered starting product comes into contact with the CO₂ after pressing and compacting, the dewatered starting product should be pressed into pellets for further processing.

Fully automatic tablet press machines are particularly suitable for this purpose. During the pressing process, a small amount of the dewatered starting product, which is available in powder form, is filled into a metal mold and compacted with a suitable tool. After the pressing process, the porosity of the pressed pellets can be determined from the ratio of bulk density and pure density.

The porosity should be less than 30% by volume, advantageously less than 20% by volume, preferably less than 10% by volume, even better less than 5% by volume. However, it is advantageous if a low residual porosity remains so that the CO₂ can penetrate into the pellet.

The pressing process can be improved by adding water, organic liquids and other substances that facilitate the compaction of the powder. Low porosity after the pressing process ensures high strength. Furthermore, the pellets are preferably available in a green strength after the pressing process, which facilitates further processing, such as transportation and treatment with CO₂.

The strength of the hardened pellets can be further increased if the powder is mixed with other substances before the pressing process, which increase the strength through additional chemical reactions. These substances include, for example, NaOH, KOH, Ca(OH)₂ and other compounds that release alkalis and/or alkaline earths, sodium aluminate, coal fly ash, trass, tempered clays and other materials that contain Al₂O₃, CaO, and/or alkalis in a form that allows them to react with SiO₂ during treatment with CO₂, preferably in an autoclave. No materials containing alite or belite should be added, as this can have a negative effect on hardening.

After heat treatment, the dewatered magnesium silicate hydrate is available as a powder and can be pressed, if necessary, with the addition of other substances. The pressing process allows a green strength to be achieved, which facilitates further processing. In contrast, the pressing process does not produce a permanent strength that allows it to be used as gravel.

In order to build up a high compressive strength in the pressed particles, chemical reactions are required to cement and hold the structure together. Several reactions take place on contact with CO₂, which contribute in different ways to a permanent strength of the gravel particles. One reaction is the formation of magnesium carbonate or magnesium carbonate hydrate from the dewatered magnesium silicate hydrate. This takes place with consumption of the dewatered magnesium silicate hydrate. The magnesium combines with the CO₂ and the SiO₂ is deposited as an amorphous phase. This results in an increase in volume, as the CO₂ penetrates the pressed particles from the outside. The increase in volume is even greater when magnesium carbonate hydrate is formed. The greater the increase in volume during the chemical reaction is, the more of the porosity that remains after pressing can be filled in. The lower the porosity is, the higher is the strength. Furthermore, the formation of new phases causes all phases to cement together and thus build up a permanent strength that is required for use as gravel.

The second reaction, which causes a permanent solidification of the pressed particles, is the hydration of the dewatered magnesium silicate hydrate. Phases such as antigorite, talc and lizardite are formed in this process. This hydration reaction is comparable to the hardening of hardened cement paste with the difference that M-S-H is formed instead of C-S-H.

The third chemical reaction that causes solidification is the chemical reaction of the SiO₂ from the carbonation with substances that were added before the particles are pressed. In the presence of reactive aluminum and alkalis, N-A-S-H phases are formed, which also occur during the solidification of geopolymers. In the presence of reactive CaO, the SiO₂ can also be converted to C-S-H.

All three reactions contribute to the reduction of porosity and the solidification of the pressed particles, which can then be used as gravel for concrete production and other purposes. The extent of the three reactions can be controlled by the external conditions, such as pressure and temperature, as well as the chemical composition and availability of CO₂.

If pressing takes place after contact with CO₂, the pressed particles do not contain dewatered magnesium silicate hydrate, but magnesium carbonate and SiO₂, and possibly other phases. This means that the formation of magnesium carbonate and magnesium carbonate hydrate can no longer contribute to strength formation, or only to a small extent. Instead, the solidification is based on the chemical reaction of substances that were added after contact with CO₂. When reactive aluminum and reactive alkalis are added, they can react with the amorphous SiO₂ from sequestration to N-A-S-H and enable strength formation. The same applies to the addition of reactive CaO and the formation of C-S-H. Dewatered magnesium silicate hydrate can also be added, which is converted to M-S-H. Other organic and inorganic binders can also be used.

If the dewatered starting product comes into contact with the CO₂ before pressing and compacting, it remains powdery or forms a powder. This process is explained in detail further below. To produce the aggregate, the dewatered magnesium silicate hydrate should therefore be solidified by contacting with CO₂.

This solidification is advantageously based on a reaction of the amorphous SiO₂ (equation 5) with added substances. These include substances that introduce Al₂O₃, alkalis or CaO in a reactive form, such as hard coal fly ash, granulated blast furnace slag, tempered clays, sodium aluminate, NaOH, KOH. Portland cement clinker should not be added. After addition, intensive homogenization is possible and advantageous. If the materials are mixed in dry form, joint grinding is conceivable. In addition to the materials mentioned, other binding agents can also be used to bind the gravel particles, such as organic adhesives.

The pretreated material can then be pressed into solid bodies. In this process, the porosity after the pressing process should be less than 30% by volume, preferably less than 20% by volume, more advantageously less than 10% by volume, even better less than 5% by volume. The pressed solids may contain a small amount of water. This water can be added before or after the pressing process. The gravel particles are hardened by a reaction of the amorphous SiO₂ from the sequestration with Al₂O₃ and alkalis from the additions, under forming N-A-S-H phases. At the same time, the formation of C-S-H phases takes place in the presence of reactive CaO or through other chemical reactions or physical processes.

These reactions are facilitated by raising the temperature to 40° C., even better to 60° C. for at least 2 hours, advantageously 12 hours, preferably 24 hours, which increases the strength of the gravel particles. Therefore, the solids are advantageously thermally treated for at least 2 hours, in particular for at least 24 hours, at temperatures of at least 40° C., preferably at least 60° C. The gravel particles should be protected from drying out. This can be done with an appropriate level of humidity in a treatment device, such as an autoclave. Preferably, the atmosphere is saturated in regard with water vapor.

Irrespective of whether the contacting of the dewatered starting product with CO₂ takes place before or after the production of the solids, the contacting can advantageously be carried out in a closed container, in particular in an autoclave, or a container with overpressure. In this way, the CO₂ binding process can be optimized, for example by adjusting the CO₂ partial pressure, the temperature present and/or the water content in the atmosphere in the autoclave.

The CO₂ is bound particularly quickly if the dewatered starting product is contacted with CO₂ after pressing and compression at a CO₂ partial pressure of at least 0.1 bar or if the dewatered starting product is contacted with CO₂ before pressing and compression at a CO₂ partial pressure of at least 0.0003 bar, preferably 0.0010 bar. The temperatures during the course of the reactions can be at least 30° C., preferably above 50° C., while the dewatered starting product is in contact with CO₂. The CO₂ partial pressure can also be below 0.5 bar.

Furthermore, it is preferable to add substances such as sugar or other organic additives that reduce the formation of magnesium silicate hydrate to the dewatered starting product before or during contact of the dewatered starting product with CO₂. This has the effect of increasing the amount of magnesium carbonate formed.

If the treatment or contact with CO₂ takes place after pressing and compacting, it is advantageous for the formation of magnesium carbonate or magnesium carbonate hydrate if the solids, such as pellets, are moist. The reaction takes place faster in the presence of water, as the activation energy for the reaction is lower.

The introduction of water can be achieved by spraying the pressed pellets with water. It is also possible to create an atmosphere in an autoclave that is saturated in regard with water vapor. A combination of the two variants is particularly suitable for introducing water.

The presence of water facilitates the dissolution of the dewatered starting product, such as tempered serpentinite, and the formation of magnesium carbonate and SiO₂. Instead of SiO₂, other silicon-containing phases can also form if other starting materials are present that provide CaO, Al₂O₃ and/or alkalis.

On the other hand, the presence of water can also enable the formation of magnesium silicate hydrates. If this occurs, the formation of magnesium silicate hydrate also contributes to the strength of the aggregate. However, the formation of magnesium silicate hydrate is a competitive reaction to the formation of magnesium carbonate or magnesium carbonate hydrate and therefore reduces the CO₂ binding capacity.

For this reason, it is advisable to control and, if necessary, reduce the formation of magnesium silicate hydrate. This can be done by selecting the reaction parameters or by adding substances that can suppress the formation of magnesium silicate hydrate. These include substances such as sugar, as the formation of magnesium silicate hydrate can be reduced or completely avoided in the presence of dissolved sugar. Certain organic additives are also suitable. All these substances should be added in dissolved form or mixed in before the solids are produced.

The reaction with CO₂ takes place by diffusion of the gas into the solids and the formation of magnesium carbonate and/or magnesium carbonate hydrate. The diffusion of the gas into the solids is facilitated by a high CO₂ partial pressure. Accordingly, the reaction can preferably be carried out in a closed container, as otherwise the CO₂ partial pressure drops again.

Closed steel containers, also known as autoclaves, are particularly suitable as they can withstand high pressures and can also be operated at elevated temperatures. The CO₂ can be fed to the autoclave filled with the solids in pure or diluted form. For this purpose, it is advantageous if the CO₂ comes from the exhaust gas or exhaust air from production plants that lead to an increase in the CO₂ partial pressure compared to normal air.

Such flue gases are produced, for example, in steelworks, glassworks, cement kilns, fossil fuel-fired power plants and other industrial processes. The CO₂ content of the flue gases is often between 5% and 30% by volume. The use of these gases is advantageous, as compressing the gases with an increased CO₂ concentration is sufficient to allow CO₂ to bind in the solids in the autoclave.

This allows CO₂ partial pressures of between 0.1 bar and 15 bar to be achieved in the autoclave. If the process of CO₂ absorption in the autoclave is to be accelerated, the CO₂ can be separated from the air or the aforementioned exhaust gases and introduced into the autoclave in almost pure form. Separation can be carried out by using conventional methods such as amine washing or calcium looping. This means that higher CO₂ partial pressures of between 1 bar and 50 bar can be achieved in the autoclave. To facilitate technical applicability, the pressure should be below 10 bar.

The formation of magnesium carbonate can be accelerated by increasing the temperature. This also increases the CO₂ partial pressure in the autoclave. Another advantage of increasing the temperature is that the formation of anhydrous magnesium carbonate (magnesite, MgCO₃) instead of magnesium carbonate hydrate (nesquehonite, MgCO₃·3H₂O) is favored.

The temperature should be at least 25° C., preferably 50° C., but less than 70° C.

The formation of magnesite can also be facilitated if magnesite nuclei are added by mixing to the dewatered starting product before the solids are pressed. The solids should be treated in the autoclave for at least 4 hours, preferably for 12 hours, even better for 24 hours, wherein the atmosphere should be saturated with water and/or the CO₂ partial pressure should be kept permanently at a high level, in which bound CO₂ is replaced by supplying new CO₂.

If contacting the dewatered starting product with CO₂ before pressing and compacting is desired, this can be carried out in an aqueous suspension by blowing in gas containing CO₂.

Contact with CO₂ can take place in a closed container, such as a scrubber or an autoclave. A suspension of water, possibly with additives, and the dewatered starting product in powder form, for example the tempered serpentinite, can be placed in this. Here too, the atmosphere can be saturated in regard with water vapor. Furthermore, substances can be added to facilitate the CO₂ binding reaction.

These substances, such as citric acid, acetic acid or KH₂PO₄ can, for example, facilitate the binding of CO₂ by buffering the pH value to values below 8.0, preferably below 7.0, even better below 6.0, as less magnesium silicate hydrate is present. Furthermore, substances can be added which suppress a formation of magnesium silicate hydrate and thus facilitate the formation of magnesium carbonate or magnesium carbonate hydrate. These include, for example, sugar and certain organic additives. NaCl should not be added to the solution, as this slows down or even prevents the reaction. The addition of magnesite nuclei is recommended.

The suspension is preferably moved continuously. This can be done by using an agitator. Furthermore, a gas containing CO₂ can be blown into the suspension. This can be air, flue gas, other waste gases from industrial processes or pure CO₂. A CO₂ partial pressure of 0.0003 bar, preferably 0.0010 bar, even better 0.0100 bar, particularly advantageous 0.3000 bar is sufficient for the reaction. The total pressure should be below 10 bar, preferably below 2 bar, in order to be able to reduce the requirements for the mechanical stability of the container. The CO₂ partial pressure should be less than 0.5 bar, in order to reduce the effort required to enrich CO₂ in the gas introduced.

In the suspension, the dewatered starting product reacts with the introduced CO₂ and magnesium carbonate or magnesium carbonate hydrate and amorphous SiO₂ are formed (equation 5). In some cases, the formation of magnesium silicate hydrate can occur as a competitive reaction.

It is advantageous if the operating temperature of the treatment unit, in particular the scrubber, is above room temperature, as this accelerates the chemical reactions. This heating can be achieved, for example, by introducing hot flue gas. The temperature in the scrubber should be at least 30° C., preferably 50° C. However, the solubility of CO₂ decreases with increasing temperature and the temperature increase should be limited to 70° C. The process can work with very low CO₂ partial pressures, which are preferably below 0.5 bar.

Preferably, the contacting with CO₂, the production of the suspension and the precipitation of the resulting magnesium carbonate or magnesium carbonate hydrate can take place in one container, which can also be referred to as a reactor, ideally at the same time. A single-stage process can therefore be provided in which the reactions preferably take place in just one container, for example an autoclave. This simplifies the overall process, especially in industrial applications, as on the one hand several, possibly even different, reactors are not used in downstream processes and on the other hand no time-consuming separation of individual intermediate products is required. The suspension also does not have to be pumped around.

It is advantageous if the dewatered starting product contacted with CO₂ is subsequently separated from the aqueous suspension and optionally subjected to thermal treatment, preferably in an autoclave, especially if more than 20% by mass magnesium carbonate hydrate, such as nesquehonite, is present.

The remaining solution can be reused to continue the sequestration process with fresh dewatered starting product. The solid material in the form of the dewatered starting product contacted with CO₂ can be further processed in dried or undried form.

It is advantageous if the dewatered starting product contacted with CO₂, which can also be referred to as the sequestration product, contains anhydrous magnesium carbonate (magnesite) and the proportion of magnesium carbonate hydrate such as nesquehonite should not be higher than 20% by mass, or even better less than 10% by mass of the total material. If the proportion of magnesium carbonate hydrate is too high after sequestration, thermal treatment can be carried out after the reaction with CO₂, in order to convert the magnesium carbonate hydrate into anhydrous magnesium carbonate. This can be done, for example, by treatment in an autoclave at 100° C. to 200° C. or by drying at 150° C. to 300° C.

As already described, before pressing and compacting and after separation from the aqueous suspension, substances that introduce Al₂O₃, alkalis or CaO in reactive form, dewatered magnesium silicate hydrate and/or organic adhesives can be added and homogenization can be carried out.

To provide the starting product with a fineness corresponding to a BET surface of 0.1 m²/g or finer, it is preferable if the starting product is subjected to grinding, in particular wet grinding. The starting product is available at least partially—even if it is already very fine in part due to natural weathering—not present in a higher fineness. This fineness can easily be increased by grinding. Wet grinding is also preferred here, as this is often more energy-efficient than dry grinding.

Furthermore, the invention relates to an aggregate produced by the method according to the invention and comprising magnesium carbonate hydrate and/or magnesium carbonate.

The aggregate is inert and can be further processed into concrete together with a hydraulic binder such as cement clinker. Further crushing may be necessary for this. In principle, it is advantageous for the sequence of the method according to the invention if at least the starting product is free of cement clinker. In particular, this can mean that it has no or hardly any (less than 0.1% by mass) alite and/or belite phases. According to experiences, the materials present in the cement clinker partially slow down the reactions explained here, so that their presence is not desirable. In small quantities, however, cement clinker is harmless.

Optionally, other substances can be added for mixing, which improve the reactivity or modify the properties of the hardened material. These substances include organic additives, in particular superplasticizers, rock flours, in particular limestone, dolomite and olivine, pozzolanic additives such as trass, glass powder, hard coal fly ash and/or thermally activated clays.

The starting products provided according to the invention are usually not pure substances, so that impurities are present to a high degree. However, it is advantageous if at least the molar ratio of Mg to Ca is 10:1 or greater and/or the molar ratio of Si to Al is also 10:1 or greater. It has been shown that the presence of calcium and aluminum in each case in relation to magnesium and silicon respectively slows down the reactions or in some cases brings them to a complete standstill. It is therefore not insignificant to shift the corresponding molar ratios significantly in the direction of magnesium or silicon. Preferably, the molar ratio of Mg to Ca is at least 20:1 and/or the molar ratio of Si to Al is at least 20:1.

1. A method for producing an aggregate, comprising the steps of:
a) providing a starting product comprising at least 20% by mass of magnesium silicate hydrate and
crushing, in particular grinding, to a fineness corresponding to a BET surface area of 0.1 m²/g or finer,
b) homogenizing the starting product,
c) at least partially dewatering the starting product from bound water by means of thermal treatment in a thermal treatment unit, wherein during thermal treatment the converted starting product is treated at a temperature between 180° C. and 1000° C.,
wherein, after step c), magnesium silicate hydrate present in the dewatered starting product is at least partially dewatered and can thereby be converted into dewatered magnesium silicate hydrate,
d) contacting the dewatered starting product with CO₂, wherein CO₂ reacts with the dewatered magnesium silicate hydrate and the CO₂ is bound in the resulting magnesium carbonate hydrate and/or magnesium carbonate,
e) pressing and compacting the dewatered starting product before or after step
d) into solids to produce the aggregate.

2. The method according to claim 1,
wherein
the thermal treatment of the starting product is carried out at a temperature of at least 550° C. and/or at most 750° C., and
the starting product is thermally treated for at least 15 minutes, preferably 30 minutes, more preferably at least 60 minutes.

3. The method according to claim 1,
wherein
the thermal treatment unit has an essentially homogeneous temperature distribution.

4. The method according to claim 1,
wherein
a rotary kiln, in particular an indirectly heated rotary kiln without open flames in the reaction chamber, is used as the thermal treatment unit.

5. The method according to claim 1,
wherein
the pressing and compacting is carried out to form solids with a volume of between 1 mm³ and 30,000 mm³.

6. The method according to claim 1,
wherein
the pressing and compacting is carried out, in order to form the solids with a porosity of less than 20% by volume, advantageously less than 10% by volume.

7. The method according to claim 1
wherein
a thermal treatment of the solids for at least 2 h, in particular for at least 24 h, at temperatures of at least 40° C., preferably at least 60° C.

8. The method according to claim 1,
wherein
the contacting of the dewatered starting product with CO₂ is carried out in a closed container, in particular in an autoclave, a scrubber or a container with overpressure.

9. The method according to claim 1,
wherein
the contacting of the dewatered starting product with CO₂ after pressing and compression is carried out with a CO₂ partial pressure of at least 0.1 bar or in that the contacting of the dewatered starting product with CO₂ prior to pressing and compression is carried out with a CO₂ partial pressure of at least 0.0003 bar, preferably 0.0010 bar.

10. The method according to claim 1,
wherein
the contacting of the dewatered starting product with CO₂ is carried out at a temperature of at least 30° C., preferably above 50° C.

11. The method according to claim 1,
wherein,
before or during the contacting of the dewatered starting product with CO₂, substances such as sugar or other organic additives are added to the dewatered starting product, which reduce the formation of magnesium silicate hydrate.

12. The method according to claim 1,
wherein
the contacting of the dewatered starting product with CO₂ is carried out before step e) in an aqueous suspension by blowing in gas containing CO₂.

13. The method according to claim 12,
wherein
the dewatered starting product contacted with CO₂ is separated from the aqueous suspension, and
is optionally subjected to thermal treatment, preferably in an autoclave, especially if more than 20% by mass magnesium carbonate hydrate is present.

14. The method according to claim 13,
wherein,
before pressing and compacting in step e) and after separation from the aqueous suspension, substances which introduce Al₂O₃, alkalis or CaO in reactive form, dewatered magnesium silicate hydrate, and/or organic adhesives are added and homogenization takes place.

15. An aggregate, prepared by a method according to claim 1, comprising magnesium carbonate hydrate and/or magnesium carbonate.
